(19) United States
(12) Patent Application Publication
(10) Pub. No.: US 2025/0307199 A1
(43) Pub. Date: Oct. 2, 2025

(54) METHOD, APPARATUS, ELECTRONIC DEVICE, AND STORAGE MEDIUM FOR CHIP CONTROL

(71) Applicant: Beijing Zitiao Network Technology Co., Ltd., Beijing (CN)

(72) Inventor: Shiqing DENG, Beijing (CN)

(21) Appl. No.: 19/090,178

(22) Filed: Mar. 25, 2025

(30) Foreign Application Priority Data
Mar. 29, 2024 (CN) 202410382384.1

(51) Int. Cl. G06F 13/42

(52) U.S. Cl. CPC G06F 13/4282

(57) ABSTRACT

The present disclosure provides a method, an apparatus, an electronic device and a storage medium for chip control. The method is applied at a first chip in communication connection with a second chip through SPI. The method includes: transmitting a status query signal to the second chip through the SPI; receiving a first signal transmitted by the second chip through the SPI, and in response to the first signal being a first preset status signal, transmitting first transmission data to the second chip through the SPI; after finishing transmitting the first transmission data to the second chip through the SPI, retransmitting the status query signal to the second chip through the SPI; and receiving a second signal returned by the second chip through the SPI, and determining a status of the second chip according to the second signal.

### CROSS-REFERENCE TO RELATED APPLICATION(S)

This application claims priority to Chinese Application No. 202410382384.1 filed on Mar. 29, 2024, the disclosure of which is incorporated herein by reference in its entirety.

### FIELD

The present disclosure relates to the field of computer technologies, and in particular, to a method, an apparatus, an electronic device, and a storage medium for chip control.

### BACKGROUND

Serial Peripheral Interface (SPI) refers to a full-duplex serial peripheral interface, and is widely used for short-distance communication between a System-on-a-Chip (SOC) and various peripheral devices. The SPI generally has four signal wires: SCLK (Serial Clock, a clock signal wire, which is generated by a master device to synchronize data transmission), MISO (Master Input/Slave Output, data input of the master device and data output of the slave device), MOSI (Master Output/Slave Input, data output of the master device and data input of the slave device), and CS (Chip Select, a chip select wire, which is controlled by the master device to select a specific slave device for communication).

### SUMMARY

The present disclosure provides a method, an apparatus, an electronic device and a storage medium for chip control.

The present disclosure adopts the following technical solutions.

In some embodiments, the present disclosure provides a method for, wherein the method is applied to a first chip in communication connection with a second chip through an SPI. The method comprises: transmitting a status query signal to the second chip through the SPI; receiving a first signal transmitted by the second chip through the SPI, and in response to the first signal being a first preset status signal, transmitting first transmission data to the second chip through the SPI; after finishing transmitting the first transmission data to the second chip through the SPI, retransmitting the status query signal to the second chip through the SPI; and receiving a second signal returned by the second chip through the SPI, and determining a status of the second chip according to the second signal.

In some embodiments, the present disclosure provides an apparatus for chip control at a first chip in communication connection with a second chip through the SPI. The apparatus includes: a transmitting unit configured to transmit a status query signal to the second chip through the SPI; a receiving unit configured to receive a first signal transmitted by the second chip through the SPI; wherein the transmitting unit is further configured to, in response to the first signal being a first preset status signal, transmit first transmission data to the second chip through the SPI; the transmitting unit is further configured to, after finishing transmitting the first transmission data to the second chip through the SPI, retransmit the status query signal to the second chip through the SPI; and the receiving unit is further configured to receive a second signal returned by the second chip through the SPI, and determine a status of the second chip according to the second signal.

In some embodiments, the present disclosure provides an electronic device, including: at least one memory and at least one processor, where the memory is used for storing program codes, and the processor is used for calling the program codes stored in the memory to perform the above method.

In some embodiments, the present disclosure provides a computer-readable storage medium, used for storing program codes, where the program codes, when run by a processor, cause the processor to perform the above method.

### BRIEF DESCRIPTION OF THE DRAWINGS

The above and other features, advantages and aspects of the embodiments of the present disclosure will become more apparent when taken in conjunction with the drawings and with reference to the following detailed description. Throughout the drawings, the same or similar reference numerals indicate the same or similar elements. It should be understood that the drawings are schematic and that the elements and elements are not necessarily drawn to scale.

FIG. 1 is a flow chart of a method for chip control according to some embodiments of the present disclosure.

FIG. 2 is an interaction sequence diagram of a first chip according to some embodiments of the present disclosure.

FIG. 3 is an interaction flow chart of a second chip according to some embodiments of the present disclosure.

FIG. 4 is a schematic structural diagram of an electronic device according to some embodiments of the present disclosure.

### DETAILED DESCRIPTION OF EMBODIMENTS

It can be understood that before the technical solutions disclosed in the embodiments of the present disclosure are used, the user shall be informed of the type, range of use, use scene, and the like of the personal information involved in the present disclosure in an appropriate manner in accordance with the relevant laws and regulations, and the authorization of the user shall be obtained.

For example, in response to receiving an active request from the user, prompt information is sent to the user, so as to clearly prompt the user that an operation requested to be performed by the user will require acquisition and use of the personal information of the user. Therefore, the user can independently select, according to the prompt information, whether to provide the personal information to software or hardware such as an electronic device, an application, a server, or a storage medium that performs the operation of the technical solutions of the present disclosure.

As an optional but non-limiting implementation, the manner of sending the prompt information to the user in response to receiving the active request from the user may be, for example, a pop-up window; and the prompt information may be presented in text in the pop-up window. In addition, the pop-up window may further include a selection control for the user to select “consent” or “disagree” to provide personal information to the electronic device.

It can be understood that the above process of notifying and acquiring user authorization is only illustrative and does not limit the implementations of the present disclosure, and other manners that meet the relevant laws and regulations may also be applied to the implementations of the present disclosure.

It can be understood that the data (including but not limited to the data itself, the acquisition or use of the data) involved in the technical solutions shall comply with the requirements of corresponding laws, regulations and related regulations.

The embodiments of the present disclosure will be described in more detail below with reference to the drawings. Although some embodiments of the present disclosure are shown in the drawings, it should be understood that the present disclosure may be implemented in various forms and should not be construed as limited to the embodiments set forth herein. On the contrary, these embodiments are provided for a more thorough and complete understanding of the present disclosure. It should be understood that the drawings and embodiments of the disclosure are only for exemplary purposes and are not intended to limit the scope of protection of the present disclosure.

It should be understood that the various steps described in the method implementations of the present disclosure may be performed sequentially and/or in parallel. Furthermore, the method implementations may include additional steps and/or omit performing the illustrated steps. The scope of the present disclosure is not limited in this respect.

As used herein, the term “include/comprise” and its variants are open-ended inclusions, i.e., “include/comprise but not limited to”. The term “based on” is “based, at least in part, on”. The term “an embodiment” means “at least one embodiment”; the term “another embodiment” means “at least one other embodiment”; the term “some embodiments” means “at least some embodiments”. Related definitions of other terms will be given in the description below.

It should be noted that concepts such as “first” and “second” mentioned in the present disclosure are only used to distinguish different apparatuses, modules or units, and are not used to limit the sequence of functions performed by these apparatuses, modules or units or their interdependence.

It should be noted that the modification of “one” mentioned in the present disclosure is illustrative rather than restrictive, and those skilled in the art should understand that unless the context clearly indicates otherwise, it should be understood as “one or more”.

The names of messages or information exchanged between apparatuses in the implementations of the present disclosure are only for illustrative purposes, and are not intended to limit the scope of these messages or information.

The solutions provided by the embodiments of the present disclosure will be described in detail below with reference to the drawings.

Data transmission or message transmission between SOC chips is usually carried out by using an SPI bus, but it is different from the use of the SPI bus between SOC chips and peripheral devices. SOC chips usually run complex services, unlike the peripheral devices that only perform a single specific task and the code of the peripheral devices is firmware so that the corresponding actual processing time can be standardized. For the communication behavior between two SOC chips, it is usually related to comprehensive influence such as operating frequency, manufacturing process, software update and multi-task scheduling, especially for two SOC chips running in different clock domains, their time references are inconsistent. Therefore, when the SOC chips need to use a certain bus to implement a certain interaction protocol, status synchronization needs to be considered. Generally, a slave (slave SOC chip) needs to inform a host (master SOC chip) of its current operating status through a certain mechanism; otherwise, the host may transmit an instruction when the slave cannot respond to the instruction, and thus the slave will not be able to respond to the instruction of the host, which may cause the host to mistakenly think that the slave system is abnormal. In this case, it may cause a response to the instruction to time out in a light case, and may cause the system to abnormally collapse in a serious case.

The timing control of the interaction protocol between a SOC chip and a peripheral device connected through the SPI is usually ensured by the SOC chip side through an active delay according to a Data Sheet document of the peripheral device. However, this manner may be not suitable for a protocol interaction scenario between SOC chips, and it is not reliable to ensure the timing by using an active delay on a host side. For interaction between SOC chips, a common usage is to express an idle or busy status of a slave through an additional General-purpose input/output (GPIO) signal wire, and a host is informed of a current status of the slave through a level signal of the GPIO, which is also widely used in many protocols.

Since the operating timing of a SOC chip is affected by various factors, in order to ensure the stable and reliable protocol interaction, an actual status feedback mechanism must be relied on, for example, an independent GPIO signal wire is used to express the operating status of a slave. However, this manner requires introduction of an additional new GPIO, which results in resource consumption. On the other hand, this manner is not applicable in some special scenarios. For example, when code needs to run in a chip initialization (bootrom) stage, since the code in the bootrom stage is solidified on an internal Read-Only Memory (ROM) of the chip in the chip manufacturing stage, which is not changeable, the manner of performing status synchronization by using the GPIO signal wire needs to be forcibly bound to a fixed GPIO signal wire, which seriously hinders flexible configuration of the GPIO signal wire of the chip.

According to the method for chip control provided by the embodiments of the present disclosure, the first transmission data is transmitted if the first signal is the first preset status signal, and characteristics of an SPI slave that a previous transmission word is repeated when a first-in first-out memory is empty is employed, such that the status of the second chip can be determined through the second signal, and status synchronization between chips is achieved. Status synchronization can be achieved using only SPI bus resources without general-purpose input/output (GPIO) signal wire.

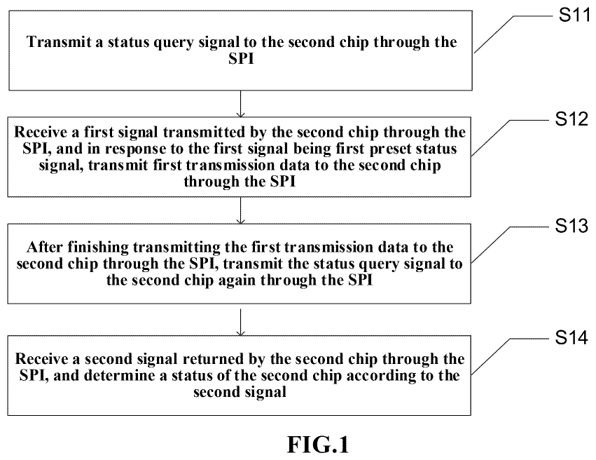

FIG. 1 is a flow chart of a method for chip control according to some embodiments of the present disclosure. The method is applied to a first chip, and the first chip is in communication connection with a second chip through the SPI. The first chip and the second chip may be two SOC chips in a dual-core heterogeneous system. The first chip may be a master SOC chip, and the second chip may be a slave SOC chip. The computing power of the master SOC chip may be greater than that of the slave SOC chip. The method for chip control in the embodiment of the present disclosure may include the following steps.

S11, transmit a status query signal to the second chip through the SPI.

In some embodiments, the first chip may transmit the status query signal to the second chip through a MOSI signal wire in the SPI. The status query signal is used for querying a status of the second chip, and may be a query protocol code, which needs to be distinct from a default level signal. For example, the status query signal may be 0xFF (hexadecimal, also expressed as FFh).

S12, receive a first signal transmitted by the second chip through the SPI, and in response to the first signal being a first preset status signal, transmit first transmission data to the second chip through the SPI,

In some embodiments, after the first chip transmits the status query signal to the second chip, the second chip transmits the first signal to the first chip. The first chip may receive the first signal transmitted by the second chip through the MISO signal wire. A determination is made based on the received first signal. The first preset status signal is pre-recorded in the first chip, and if the first signal is the same as the first preset status signal, this indicates that the second chip can receive the first transmission data, therefore, the first transmission data is transmitted to the second chip through the MOSI signal wire. The first preset status signal may be 0x00 (also expressed as 00h), that is, a zero level, and the zero level is stable and not prone to a transition. Through this step, a tx (Transmitter) fifo (first in first out) of the second chip (slave end) is filled with the first preset status signal 0x00. and the signal transmitted by the second signal may be a signal in the fifo memory of the second chip. The first transmission data may be a control instruction or a control instruction and data.

S13, after finishing transmitting the first transmission data to the second chip through the SPI. retransmit the status query signal to the second chip through the SPI.

In some embodiments, after the first chip transmits the first transmission data, the operation of transmitting the status query signal to the second chip through the MOSI signal wire will be repeatedly performed. When the processor of the second chip receives or parses the first transmission data, the processor of the second chip cannot transmit data to the fifo of the second chip at the same time. At this time, a status of the fifo is unchanged, and the fifo will repeat the previous transmission word, that is, the first preset status signal 0x00 will be repeatedly transmitted. By using this characteristic, whether the second chip is in a busy status can be determined.

S14, receive a second signal returned by the second chip through the SPI, and determine a status of the second chip according to the second signal.

In some embodiments, the second signal is received through the MISO signal wire. If the second chip is in the busy status, the second signal returned by the second chip will not change compared with the first signal returned previously. This is because a SPI slave (slave chip end) tx (Transmitter) fifo (first in first out) has a characteristic of repeating transmitting the previous transmission word when the SPI slave tx fifo is empty, and the second chip cannot write data into the fifo at the same time during processing the first transmission data. At this time, the second signal transmitted by the fifo of the second chip to the first chip will not change compared with the first signal transmitted previously. Therefore, if the second signal is the same as the first signal, it indicates that the second chip has not finished processing the first transmission data, and if the second signal is different from the first signal, it indicates that other conditions occur.

In some embodiments, the first transmission data is transmitted when the first signal is the first preset status signal, and a characteristic of an SPI slave tx fifo that a previous transmission word is repeated when the SPI slave tx fifo is empty is employed. In this way, the status of the second chip can be determined through the second signal, and status synchronization between chips is achieved. No GPIO signal wire is introduced, and status synchronization is realized by only SPI bus resources.

In some embodiments of the present disclosure, determining the status of the second chip according to the second signal includes: if the second signal is the first preset status signal, determining that the second chip is in a process of processing the first transmission data. In some embodiments, the first signal transmitted by the second chip before the first transmission data is transmitted is the first preset status signal, and the signal is unchanged during the second chip processing the first transmission data, so if the second chip is still processing the first transmission data, the second signal is still the first preset status signal. When the second signal is the first preset status signal, it can be determined that the second chip is still processing the first transmission data.

In some embodiments of the present disclosure, determining the status of the second chip according to the second signal includes: if the second signal is header data of response data, determining that the second chip finishes processing the first transmission data, where the first transmission data includes data carrying the response data. In some embodiments, when the data in the first transmission data carries the response data, the second chip will transmit the response data to the first chip according to the received status query signal after finishing processing the first transmission data, that is, the response data in the first transmission data is data that the first chip requires the second chip to transmit back to the first chip. If the first chip receives the response data transmitted back by the second chip, it indicates that the second chip normally receives and processes the first transmission data, and therefore can correctly transmit back the response data. When the response data is received, the header data of the response data is received first. The header data of the response data needs to be different from other signals, such as the first preset status signal and the second preset status signal.

In some embodiments of the present disclosure, determining the status of the second chip according to the second signal includes: if the second signal is the second preset status signal, determining that the first transmission data is erroneous, where the first transmission data includes data carrying the response data. In some embodiments, as described above, when the first transmission data includes data carrying the response data, if the second chip normally receives and finishes processing the first transmission data, the second chip will transmit the response data to the first chip after receiving the status query signal. However, if the first transmission data is erroneous and the second chip fails to correctly receive the first transmission data, the second chip will be in a reception state, ready to receive data transmitted by the first chip. At this time, the second chip will return the second preset status signal indicating that the second chip is in the reception state to the first chip when receiving the status query signal, and after receiving the second preset status signal, the first chip can determine that the first transmission data is erroneous.

In some embodiments of the present disclosure, determining the status of the second chip according to the second signal includes: if the second signal is the second preset status signal, determining that the second chip finishes processing the first transmission data, where the first transmission data does not carry response data.

In some embodiments, if the first transmission data does not carry the response data, the second chip will not transmit the response data to the first chip after correctly receiving and processing the first transmission data, but will change its own status to the reception state, which corresponds to the second preset status signal. At this time, when receiving the status query signal transmitted by the first chip, the second chip will return the second preset status signal to the first chip, indicating that the second chip has correctly received and processed the first transmission data.

In some embodiments of the present disclosure, after determining that the second chip is in the process of processing the first transmission data if the second signal is the first preset status signal, the method further includes: continuing to transmit the status query signal to the second chip through the SPI until the header data of the response data transmitted by the second chip is received or the second preset status signal is received.

In some embodiments, after it is determined that the second signal is the first preset status signal, it is determined that the second chip is in the process of processing the first transmission data. In order to know when the second chip finishes processing the first transmission data, the status query signal continues to be transmitted to the second chip, for example, the status query signal may be transmitted at intervals of a preset time, until the header data of the response data or the second preset status signal is received by the first chip.

In some embodiments of the present disclosure, before the transmitting the status query signal to the second chip through the SPI, the method further includes: transmitting a third signal to the second chip through the SPI, where the third signal is used for notifying the second chip that the first transmission data is about to be transmitted to the second chip, to cause the second chip to be ready to transmit the first preset status signal. In some embodiments, before step S11, the third signal is transmitted to the second chip, and the third signal may be, for example, 0xA5 (also expressed as A5h), which is used for notifying the second chip that the first chip is about to transmit the first transmission data. After receiving the third signal, the second chip will change its own status from a reception state to a busy state, and the first preset status signal is a signal indicating that the second chip is in the busy state. After receiving the first preset status signal transmitted by the second chip, the first chip can know that the second chip is ready to receive the first transmission data.

In some embodiments of the present disclosure, before the transmitting the third signal to the second chip through the SPI, the method further includes: transmitting the status query signal to the second chip through the SPI, and receiving a third signal transmitted by the second chip through the SPI; if the third signal is the second preset status signal, performing a step of transmitting the third signal to the second chip through the SPI. In some embodiments, the second preset status signal is a signal indicating that the second chip is in the reception state, that is, in the present disclosure, it is necessary to first determine that the second chip is already in the reception state, and then determine that the second chip changes from the reception state to the busy state (corresponding to the first preset status signal), and then the first transmission data is transmitted, so as to avoid the busy state of the second chip being caused by processing other matters. Since the second chip is already in the reception state (corresponding to the second preset status signal), and then after the first chip transmits the third signal to the second chip, the second chip changes from the reception state to the busy state, therefore, the busy state of the second chip at this time is caused by preparing to receive the first transmission data. In this way, the first chip is prevented from transmitting the first transmission data to the second chip when the second chip is processing other matters.

In some embodiments of the present disclosure, if the third signal is not the second preset status signal, the step of transmitting the status query signal to the second chip through the SPI is performed again, until the second preset status signal is received. In some embodiments, the signal received after the third signal is transmitted may not be the second preset signal, which indicates that the second chip is not in the reception state and may be processing other matters, and therefore, it is necessary to wait, so the status query signal will be transmitted again. For example, the status query signal may be transmitted at intervals of a preset time, until the second preset status signal returned by the second chip is received. At this time, the second chip is already in the reception state.

In some embodiments of the present disclosure, the first chip and the second chip are chips in a dual-core heterogeneous system. A dual-core heterogeneous system is a computing platform in which the first chip and the second chip respectively contain two different processor cores, which have essential differences in architecture or performance characteristics. Such a system aims to combine the advantages of different types of processor cores, thereby providing a solution that balances high performance and energy efficiency. The dual-core heterogeneous system can use a processor core with stronger performance when a large amount of processing power is required, and use a low-power core in a scenario with low load or energy efficiency first. In the dual-core heterogeneous system, the different processor cores may be: based on different processor architectures or have different performance characteristics. For the case based on different processor architectures, for example, the core of the first chip may be based on an ARM architecture, and the core of the second chip may be based on a RISC-V architecture. For the case with different performance characteristics, the first chip may have a large core, and the second chip may have a small core. The so-called large core specializes in processing tasks that require higher computing power, while the small core processes daily tasks to save energy. This heterogeneous system combines the balance between energy efficiency and performance by intelligently scheduling tasks to appropriate cores. The method proposed in the present disclosure can be used for the dual-core heterogeneous system as described above, which is divided into the first chip and the second chip. The first chip contains a CPU, a GPU, etc., and is used for processing complex multi-task computing, scheduling and status control of the overall system; while the second chip mainly contains specific functions for processing high real-time, specific high parallel computing tasks and implementation of specific functions, such as processing image data, accelerating algorithm computing, etc. For the dual-core heterogeneous system that interacts based on an SPI bus, it is not reliable to ensure the timing by using an active delay on a host side. Since the operating timing of a SOC is affected by various factors, in order to ensure the stable and reliable protocol interaction, an actual status feedback mechanism must be relied on, for example, an independent GPIO signal wire is used to express the operating status of a slave. However, in the present disclosure, no GPIO signal wire is introduced between the first chip and the second chip, and status synchronization of the dual-core heterogeneous system is realized only by means of resources of the SPI bus.

In some embodiments of the present disclosure, the method is performed in a chip initialization (bootROM) stage. For the manner of additionally introducing a GPIO signal wire, when code needs to run in the bootrom stage, since the code in the bootrom stage is solidified on an internal ROM of the chip in the chip manufacturing stage, which is not changeable, the manner of performing status synchronization by using the GPIO signal wire needs to be forcibly bound to a fixed GPIO signal wire, which hinders flexible configuration of the GPIO of the chip. The method proposed in the present disclosure introduces no GPIO signal wire, and realizes status synchronization only by means of resources of an SPI bus, thus solving the above problem.

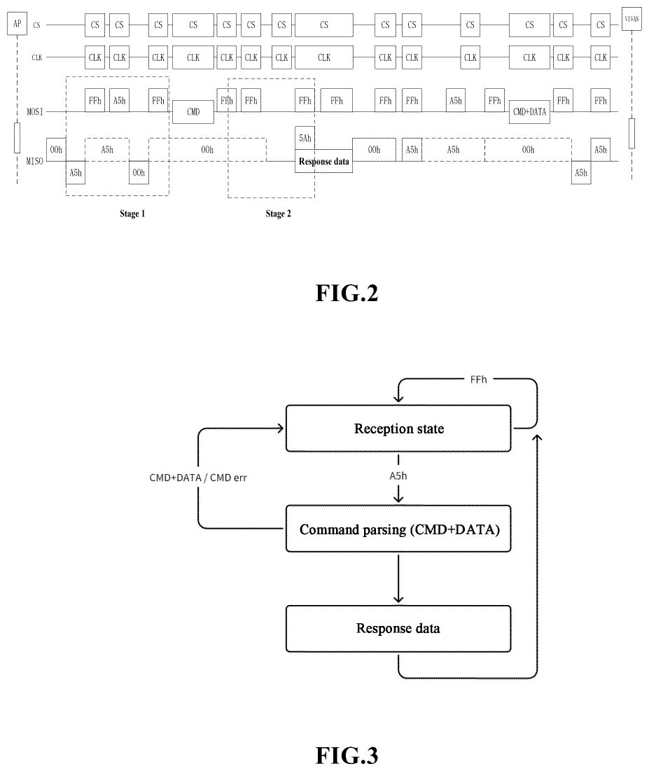

In order to better illustrate the method proposed in the present disclosure, a specific embodiment is listed below with reference to FIG. 2. In this embodiment, the first chip and the second chip are chips in a dual-core heterogeneous system, and the first chip and the second chip communicate through the SPI. The SPI has a MOSI signal wire, a MISO signal wire, a chip select line and a serial clock. CS in FIG. 2 is the chip select line, and CLK is the clock line. FIG. 2 shows timing lines (transversely arranged in parallel) of the above four signal wires of the first chip respectively, and the direction from left to right is the time direction. The signal under the timing line of the MISO signal wire is the signal that the second chip is ready to transmit. As shown in FIG. 2, the method mainly includes two parts: a stage 1 and a stage 2. The stage 1 corresponds to the first chip querying whether the second chip is in a reception state, and the stage 2 is that the first chip transmits the first transmission data with response data, and the first chip detects whether the second chip is ready to return data. The processing flow corresponding to the second chip is shown in FIG. 3, which will be described in detail through the following steps 1 to 6.

Step 1, as shown in FIG. 2, in the stage 1, referring to the MOSI timing line, the first chip transmits the status query signal FFh through the MOSI to query the status of the second chip, and if the second chip is in a busy state, the next query continues.

Step 2, as shown in FIG. 2 and FIG. 3, if the second chip is already in the reception state, full duplex will be switched on, and the second chip will put the second preset status signal A5h, which is ready to be transmitted, into the tx fifo memory as a third signal, and wait for the first chip to initiate the status query signal for query. The second preset status signal needs not to conflict with other signals.

Step 3, the first chip transmits the status query signal FFh, and after receiving the second preset status signal A5h of the second chip through the MISO, it means that the second chip enters the reception state. (If the first chip does not receive the second preset status signal, the first chip will continue to transmit the status query signal)

Step 4, after receiving the second preset status signal A5h of the second chip, the first chip transmits the third signal A5h to the second chip to indicate that the first chip is about to transmit the first transmission data. The first transmission data may be a control instruction CMD or a control instruction CMD and other data DATA, and the first transmission data may carry response data. After receiving the third signal A5h. the second chip puts the first preset status signal 00h. which is ready to be transmitted, into the tx fifo memory, and waits for the first chip to initiate the status query signal for query.

Step 5, the first chip transmits the status query signal FFh again (corresponding to step S11), to query the status of the second chip again. If the first signal returned by the second chip is the first preset status signal 00h. the first chip transmits the first transmission data CMD/CMD+DATA (corresponding to step S12); if the first signal returned by the second chip is not the first preset status signal 00h. the first chip will continue to transmit the status query signal.

Step 6, after transmitting the first transmission data, the first chip transmits the status query signal FFh again (entering stage 2) to obtain the second signal. Since the first preset status signal 00h is the transmission word transmitted when the SPI slave tx fifo is empty in step 5, and the SPI slave tx fifo has the characteristic of repeating the previous transmission word when the SPI slave tx fifo is empty, therefore, if the second signal received by the first chip is the first preset status signal 00h. it indicates that the second chip is still processing the first transmission data. If the second chip finishes processing the first transmission data normally, the second chip will return the response data. Therefore, if the received second signal is the header data 5Ah of the response data (as shown in the right part of the stage 2 in FIG. 2), it indicates that the second chip finishes processing the first transmission data. However, if the first transmission data is erroneous (as shown in FIG. 3. CMD+DATA/CMD err), the second chip will return to the reception state again, and the second signal received by the first chip will be the second preset status signal.

It can be seen from the above embodiments that the present disclosure uses the characteristic of repeating the previous transmission word when the SPI slave tx fifo is empty to realize the status synchronization between chips. There is no need to introduce additional hardware resources, and only adaptation between the first chip and the second chip is needed. The method is suitable for the bootrom stage.

The present disclosure further provides an apparatus for chip control. The apparatus may arranged at a first chip in communication connection with a second chip through the SPI. The apparatus includes: a transmitting unit configured to transmit a status query signal to the second chip through the SPI; a receiving unit configured to receive a first signal transmitted by the second chip through the SPI. The transmitting unit is further configured to, in response to the first signal being a first preset status signal, transmit first transmission data to the second chip through the SPI. The transmitting unit is further configured to, after finishing transmitting the first transmission data to the second chip through the SPI, retransmit the status query signal to the second chip through the SPI. The receiving unit is further configured to receive a second signal returned by the second chip through the SPI, and determine a status of the second chip according to the second signal.

In some embodiments, determining the status of the second chip according to the second signal includes: in response to the second signal being the first preset status signal, determining that the second chip is in a process of processing the first transmission data; or in response to the second signal being header data of response data, determining that the second chip finishes processing the first transmission data, where the first transmission data includes data carrying the response data; or in response to the second signal being a second preset status signal, determining that the first transmission data is erroneous, where the first transmission data includes data carrying response data; or in response to the second signal being a second preset status signal. determining that the second chip finishes processing the first transmission data, where the first transmission data does not carry response data.

In some embodiments, after determining that the second chip is in the process of processing the first transmission data in response to the second signal being the first preset status signal, the transmitting unit is further configured to: continue to transmit the status query signal to the second chip through the SPI until the header data of the response data transmitted by the second chip is received or the second preset status signal is received.

In some embodiments, before the transmitting the status query signal to the second chip through the SPI, the transmitting unit is further configured to: transmit a third signal to the second chip through the SPI, where the third signal is used for notifying the second chip that the first transmission data is about to be transmitted to the second chip, to cause the second chip to be ready to transmit the first preset status signal.

In some embodiments, before the transmitting the third signal to the second chip through the SPI, the transmitting unit is further configured to: transmit the status query signal to the second chip through the SPI; the receiving unit is further configured to receive a third signal transmitted by the second chip through the SPI; if the third signal is the second preset status signal, perform a step of transmitting the third signal to the second chip through the SPI.

In some embodiments, if the third signal is not the second preset status signal, the transmitting unit performs the step of transmitting the status query signal to the second chip through the SPI again, until the second preset status signal is received by the receiving unit.

In some embodiments, the control apparatus is used for control in a chip initialization stage. In some embodiments, the first chip and the second chip are chips in a dual-core heterogeneous system.

With regard to the embodiments of the apparatus, since they basically correspond to the method embodiments, reference may be made to the descriptions of the method embodiments for related parts. The apparatus embodiments described above are only illustrative, and the modules described as separate modules may be separate or may not be separate. Some or all of the modules may be selected as required to achieve the objectives of the solutions of the embodiments. Those ordinary skilled in the art may understand and implement the present disclosure without creative efforts.

Based on the embodiments and application examples, the method and apparatus of the present disclosure are illustrated above. In addition, the present disclosure further provides an electronic device and a computer-readable storage medium, which will be described below.

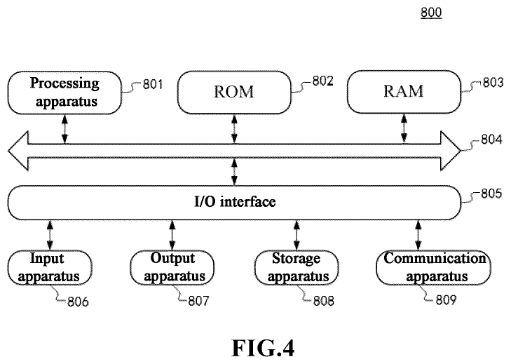

Reference is made to FIG. 4 below, which illustrates a schematic structural diagram of an electronic device (such as a terminal device or a server) 800 suitable for implementing the embodiments of the present disclosure. The terminal device in the embodiment of the present disclosure may include, but is not limited to, a mobile terminal such as a mobile phone, a notebook computer, a digital broadcast receiver, a PDA (Personal Digital Assistant), a PAD (tablet computer), a PMP (Portable Multimedia Player), a vehicle-mounted terminal (for example, a vehicle-mounted navigation terminal) and a fixed terminal such as a digital TV, a desktop computer, etc. The electronic device shown in the figure is only an example, and should not impose any restrictions on the function and scope of use of the embodiments of the present disclosure.

The electronic device 800 may include a processing apparatus (for example, a central processing unit. a graphics processing unit, etc.) 801, which may perform various appropriate actions and processes according to a program stored in a read-only memory (ROM) 802 or a program loaded from a storage apparatus 808 into a random access memory (RAM) 803. The RAM 803 further stores various programs and data required for the operation of the electronic device 800. The processing apparatus 801, the ROM 802, and the RAM 803 arc connected to each other through a bus 804. An input/output (I/O) interface 805 is also connected to the bus 804.

Generally, the following apparatuses may be connected to the I/O interface 805; an input apparatus 806 including, for example, a touchscreen, a touchpad, a keyboard, a mouse, a camera, a microphone, an accelerometer, a gyroscope, etc.; an output apparatus 807 including, for example, a liquid crystal display (LCD), a speaker, a vibrator, etc.; a storage apparatus 808 including, for example, a magnetic tape, a hard disk, etc.; and a communication apparatus 809. The communication apparatus 809 may allow the electronic device 800 to perform wireless or wired communication with other devices to exchange data. Although FIG. 4 illustrates the electronic device 800 having various apparatuses, it should be understood that it is not required to implement or have all the illustrated apparatuses. More or fewer apparatuses may alternatively be implemented or provided.

Particularly, according to the embodiments of the present disclosure, the process described above with reference to the flow chart may be implemented as a computer software program. For example, the embodiments of the present disclosure include a computer program product, which includes a computer program carried on a computer-readable medium. The computer program includes program codes for executing the method shown in the flow chart. In such an embodiment, the computer program may be downloaded and installed from a network through the communication apparatus 809, or installed from the storage apparatus 808, or installed from the ROM 802. When the computer program is executed by the processing apparatus 801, the above functions defined in the method of the embodiments of the present disclosure are executed.

It should be noted that the above computer-readable medium in the present disclosure may be a computer-readable signal medium or a computer-readable storage medium or any combination thereof. The computer-readable storage medium may be, for example, but not limited to, an electrical, magnetic, optical, electromagnetic, infrared, or semiconductor system, apparatus or device, or any combination thereof. More specific examples of the computer-readable storage medium may include, but are not limited to: an electrical connection with one or more wires, a portable computer disk, a hard disk, a random access memory (RAM), a read-only memory (ROM), an erasable programmable read-only memory (EPROM or flash memory), an optical fiber, a portable compact disk read-only memory (CD-ROM), an optical storage device, a magnetic storage device, or any suitable combination thereof. In the present disclosure, the computer-readable storage medium may be any tangible medium that contains or stores a program, and the program may be used by or used in conjunction with an instruction execution system, apparatus, or device. In the present disclosure, the computer-readable signal medium may include a data signal that is propagated in a baseband or as part of a carrier wave, and computer-readable program codes are carried therein. Such a propagated data signal may take a variety of forms, including but not limited to an electromagnetic signal, an optical signal, or any suitable combination thereof. The computer-readable signal medium may also be any computer-readable medium other than the computer-readable storage medium. The computer-readable signal medium may transmit, propagate, or transmit a program used by or in conjunction with an instruction execution system, apparatus, or device. The program codes contained on the computer-readable medium may be transmitted by any suitable medium, including but not limited to: a wire, an optical cable. RF (radio frequency), etc., or any suitable combination thereof.

In some implementations, clients and servers may communicate using any currently known or future developed network protocol, such as HTTP (HyperText Transfer Protocol), and may be interconnected with any form or medium of digital data communication (for example, a communication network). Examples of the communication network include a local area network (“LAN”), a wide area network (“WAN”), an internet (for example, the Internet), and a peer-to-peer network (for example, an ad hoc peer-to-peer network), as well as any currently known or future developed network.

The above computer-readable medium may be included in the above electronic device, or may exist alone without being assembled into the electronic device.

The above computer-readable medium carries one or more programs, and when the one or more programs are executed by the electronic device, the electronic device is caused to execute the above method of the present disclosure.

Computer program codes for performing the operations of the present disclosure may be written in one or more programming languages or combinations thereof. The programming languages include object-oriented programming languages such as Java. Smalltalk. C++, and also include conventional procedural programming languages such as the “C” language or similar programming languages. The program codes may be executed entirely on a user's computer, partly on a user's computer, as a stand-alone software package, partly on a user's computer and partly on a remote computer, or entirely on a remote computer or a server. In the case of a remote computer, the remote computer may be connected to the user's computer through any type of network, including a local area network (LAN) or a wide area network (WAN), or the connection may be made to an external computer (for example, through the Internet using an Internet service provider).

The flow charts and block diagrams in the drawings illustrate the possible architecture, functionality, and operation of a system, method, and computer program product according to various embodiments of the present disclosure. In this regard, each block in the flow chart or block diagram may represent a module, program segment, or part of code, which contains one or more executable instructions for implementing the specified logical function. It should also be noted that in some alternative implementations, the functions marked in the blocks may also occur in a different order than those marked in the drawings. For example, two blocks shown in succession may actually be executed substantially in parallel, and they may sometimes be executed in a reverse order, depending on the functions involved. It should also be noted that each block in the block diagram and/or flow chart, and a combination of blocks in the block diagram and/or flow chart, may be implemented by a dedicated hardware-based system that performs the specified functions or operations, or may be implemented by a combination of dedicated hardware and computer instructions.

The units involved in the embodiments of the present disclosure may be implemented in software or hardware. Where the name of a unit does not constitute a limitation on the unit itself under certain circumstances.

The functions described herein above may be performed, at least in part, by one or more hardware logic components. For example, without limitation, exemplary types of hardware logic components that can be used include: a field programmable gate array (FPGA), an application specific integrated circuit (ASIC), an application specific standard product (ASSP), a system on chip (SOC), a complex programmable logic device (CPLD), and so on.

In the context of the present disclosure, a machine-readable medium may be a tangible medium that may contain or store a program for use by or in combination with an instruction execution system, apparatus, or device. The machine-readable medium may be a machine-readable signal medium or a machine-readable storage medium. The machine-readable medium may include, but is not limited to, an electrical, magnetic, optical. electromagnetic, infrared, or semiconductor system, apparatus, or device, or any suitable combination thereof. More specific examples of the machine-readable storage medium may include an electrical connection based on one or more wires, a portable computer disk, a hard disk, a random access memory (RAM), a read-only memory (ROM), an erasable programmable read-only memory (EPROM or flash memory), an optical fiber, a portable compact disk read-only memory (CD-ROM), an optical storage device, a magnetic storage device, or any suitable combination thereof.

According to one or more embodiments of the present disclosure, a method for chip control is provided. The method may be applied to a first chip in communication connection with a second chip through the SPI (Serial Peripheral Interface). The method includes: transmitting a status query signal to the second chip through the SPI; receiving a first signal transmitted by the second chip through the SPI, and in response to the first signal being a first preset status signal, transmitting first transmission data to the second chip through the SPI; after finishing transmitting the first transmission data to the second chip through the SPI, retransmitting the status query signal to the second chip through the SPI; and receiving a second signal returned by the second chip through the SPI, and determining a status of the second chip according to the second signal.

According to one or more embodiments of the present disclosure, determining the status of the second chip according to the second signal includes: in response to the second signal being the first preset status signal, determining that the second chip is in a process of processing the first transmission data; or, in response to the second signal being header data of response data, determining that the second chip finishes processing the first transmission data, where the first transmission data includes data carrying the response data; or, in response to the second signal being a second preset status signal, determining that the first transmission data is erroneous, where the first transmission data includes data carrying response data; or, in response to the second signal being a second preset status signal, determining that the second chip finishes processing the first transmission data, where the first transmission data does not carry response data.

According to one or more embodiments of the present disclosure, after determining that the second chip is in the process of processing the first transmission data in response to the second signal being the first preset status signal, the method further includes: continuing to transmit the status query signal to the second chip through the SPI until the header data of the response data transmitted by the second chip is received or the second preset status signal is received.

According to one or more embodiments of the present disclosure, the method further comprises, before the transmitting the status query signal to the second chip through the SPI, transmitting a third signal to the second chip through the SPI, where the third signal is used for notifying the second chip that the first transmission data is about to be transmitted to the second chip, to cause the second chip to be ready to transmit the first preset status signal.

According to one or more embodiments of the present disclosure, the method further includes, before the transmitting the third signal to the second chip through the SPI; transmitting the status query signal to the second chip through the SPI, and receiving a third signal transmitted by the second chip through the SPI; in response to the third signal being the second preset status signal, performing a step of transmitting the third signal to the second chip through the SPI.

According to one or more embodiments of the present disclosure, in response to the third signal not being the second preset status signal, retransmitting the status query signal to the second chip through the SPI, until the second preset status signal is received.

According to one or more embodiments of the present disclosure, the method is performed at a chip initialization stage; and/or the first chip and the second chip are chips in a dual-core heterogeneous system.

According to one or more embodiments of the present disclosure, an apparatus for a chip control is provided. The apparatus is applied at a first chip in communication connection with a second chip through the SPI. The apparatus includes: a transmitting unit configured to transmit a status query signal to the second chip through the SPI; a receiving unit configured to receive a first signal transmitted by the second chip through the SPI; wherein the transmitting unit is further configured to, in response to the first signal being a first preset status signal, transmit first transmission data to the second chip through the SPI; the transmitting unit is further configured to, after finishing transmitting the first transmission data to the second chip through the SPI, retransmit the status query signal to the second chip through the SPI; and the receiving unit is further configured to receive a second signal returned by the second chip through the SPI, and determine a status of the second chip according to the second signal.

According to one or more embodiments of the present disclosure, an electronic device is provided, including: at least one memory and at least one processor, where the at least one memory is used for storing program codes, and the at least one processor is used for calling the program codes stored in the at least one memory to perform the method according to any one of the above.

According to one or more embodiments of the present disclosure, a computer-readable storage medium is provided, where the computer-readable storage medium is used for storing program codes, and the program codes, when run by a processor, cause the processor to perform the above method.

The above description is only preferred embodiments of the present disclosure and an illustration of the technical principles used. Those skilled in the art should understand that the scope of disclosure involved in the present disclosure is not limited to the technical solutions formed by the specific combination of the above technical features, and should also cover, without departing from the above disclosed concept, other technical solutions formed by any combination of the above technical features or their equivalents. For example, the above features and technical features with similar functions disclosed in the present disclosure (but not limited to) are replaced with each other to form technical solutions.

In addition, although operations are depicted in a specific order, this should not be understood as requiring these operations to be performed in the specific order shown or in a sequential order. Under certain circumstances, multitasking and parallel processing may be advantageous. Similarly, although several specific implementation details are included in the above discussion, these should not be interpreted as limiting the scope of the present disclosure. Certain features that are described in the context of separate embodiments can also be implemented in combination in a single embodiment. Conversely, various features described in the context of a single embodiment may also be implemented in multiple embodiments separately or in any suitable sub-combination.

Although the subject matter has been described in language specific to structural features and/or logical actions of the method, it should be understood that the subject matter defined in the appended claims is not necessarily limited to the specific features or actions described above. On the contrary; the specific features and actions described above are only example forms for implementing the claims.

I/we claim:

1. A method for chip control, wherein the method is applied at a first chip in communication connection with a second chip through a Serial Peripheral Interface (SPI), and the method comprises:
transmitting a status query signal to the second chip through the SPI;
receiving a first signal transmitted by the second chip through the SPI, and in response to the first signal being a first preset status signal, transmitting first transmission data to the second chip through the SPI;
after finishing transmitting the first transmission data to the second chip through the SPI, retransmitting the status query signal to the second chip through the SPI; and
receiving a second signal returned by the second chip through the SPI, and determining a status of the second chip according to the second signal.

2. The method according to claim 1, wherein determining the status of the second chip according to the second signal comprises:
in response to the second signal being the first preset status signal, determining that the second chip is in a process of processing the first transmission data; or,
in response to the second signal being header data of response data, determining that the second chip has finished processing the first transmission data, wherein the first transmission data comprises data carrying response data; or,
in response to the second signal being a second preset status signal, determining that the first transmission data is erroneous, wherein the first transmission data comprises data carrying response data; or,
in response to the second signal being a second preset status signal, determining that the second chip has finished processing the first transmission data, wherein the first transmission data does not carry response data.

3. The method according to claim 2, wherein after determining that the second chip is in the process of processing the first transmission data in response to the second signal being the first preset status signal, the method further comprises:
continuing to transmit the status query signal to the second chip through the SPI until the header data of the response data transmitted by the second chip is received or the second preset status signal is received.

4. The method according to claim 1, wherein the method further comprises, before the transmitting the status query signal to the second chip through the SPI;
transmitting a third signal to the second chip through the SPI, wherein the third signal is used for notifying the second chip that the first transmission data is about to be transmitted to the second chip, to cause the second chip to be ready to transmit the first preset status signal.

5. The method according to claim 4, wherein
before transmitting the third signal to the second chip through the SPI, the method further comprises:
transmitting the status query signal to the second chip through the SPI, and receiving a third signal transmitted by the second chip through the SPI; and
in response to the third signal being the second preset status signal, transmitting the third signal to the second chip through the SPI.

6. The method according to claim 5, wherein
in response to the third signal not being the second preset status signal, retransmitting the status query signal to the second chip through the SPI, until the second preset status signal is received.

7. The method according to claim 1, wherein, the method is performed in a chip initialization stage; and/or, the first chip and the second chip are chips in a dual-core heterogeneous system.

8. An electronic device, comprising:
at least one memory and at least one processor, wherein the at least one memory is used for storing program codes, and the at least one processor is used for calling the program codes stored in the at least one memory to perform a method applied at a first chip in communication connection with a second chip through a Serial Peripheral Interface (SPI), the method comprising:
transmitting a status query signal to the second chip through the SPI;
receiving a first signal transmitted by the second chip through the SPI, and in response to the first signal being a first preset status signal, transmitting first transmission data to the second chip through the SPI;
after finishing transmitting the first transmission data to the second chip through the SPI, retransmitting the status query signal to the second chip through the SPI; and
receiving a second signal returned by the second chip through the SPI, and determining a status of the second chip according to the second signal.

9. The electronic device according to claim 8, wherein determining the status of the second chip according to the second signal comprises:
in response to the second signal being the first preset status signal, determining that the second chip is in a process of processing the first transmission data; or,
in response to the second signal being header data of response data, determining that the second chip has finished processing the first transmission data, wherein the first transmission data comprises data carrying response data; or,
in response to the second signal being a second preset status signal, determining that the first transmission data is erroneous, wherein the first transmission data comprises data carrying response data; or,
in response to the second signal being a second preset status signal, determining that the second chip has finished processing the first transmission data, wherein the first transmission data does not carry response data.

10. The electronic device according to claim 9, wherein after determining that the second chip is in the process of processing the first transmission data in response to the second signal being the first preset status signal, the method further comprises:
continuing to transmit the status query signal to the second chip through the SPI until the header data of the response data transmitted by the second chip is received or the second preset status signal is received.

11. The electronic device according to claim 8, wherein the method further comprises, before the transmitting the status query signal to the second chip through the SPI;
transmitting a third signal to the second chip through the SPI, wherein the third signal is used for notifying the second chip that the first transmission data is about to be transmitted to the second chip, to cause the second chip to be ready to transmit the first preset status signal.

12. The electronic device according to claim 11, wherein before transmitting the third signal to the second chip through the SPI, the method further comprises:
transmitting the status query signal to the second chip through the SPI, and receiving a third signal transmitted by the second chip through the SPI; and
in response to the third signal being the second preset status signal, transmitting the third signal to the second chip through the SPI.

13. The electronic device according to claim 12, wherein
in response to the third signal not being the second preset status signal, retransmitting the status query signal to the second chip through the SPI, until the second preset status signal is received.

14. The electronic device according to claim 8, wherein,
the method is performed in a chip initialization stage; and/or,
the first chip and the second chip are chips in a dual-core heterogeneous system.

15. A computer-readable storage medium, used for storing program codes, wherein the program codes, when run by a processor, cause the processor to perform a method applied at a first chip in communication connection with a second chip through a Serial Peripheral Interface (SPI), the method comprising:
transmitting a status query signal to the second chip through the SPI;
receiving a first signal transmitted by the second chip through the SPI, and in response to the first signal being a first preset status signal, transmitting first transmission data to the second chip through the SPI;
after finishing transmitting the first transmission data to the second chip through the SPI, retransmitting the status query signal to the second chip through the SPI; and
receiving a second signal returned by the second chip through the SPI, and determining a status of the second chip according to the second signal.

16. The computer-readable storage medium according to claim 15, wherein determining the status of the second chip according to the second signal comprises:
in response to the second signal being the first preset status signal, determining that the second chip is in a process of processing the first transmission data; or,
in response to the second signal being header data of response data, determining that the second chip has finished processing the first transmission data, wherein the first transmission data comprises data carrying response data; or,
in response to the second signal being a second preset status signal, determining that the first transmission data is erroneous, wherein the first transmission data comprises data carrying response data; or,
in response to the second signal being a second preset status signal, determining that the second chip has finished processing the first transmission data, wherein the first transmission data does not carry response data.

17. The computer-readable storage medium according to claim 16, wherein after determining that the second chip is in the process of processing the first transmission data in response to the second signal being the first preset status signal, the method further comprises:
continuing to transmit the status query signal to the second chip through the SPI until the header data of the response data transmitted by the second chip is received or the second preset status signal is received.

18. The computer-readable storage medium according to claim 15, wherein the method further comprises, before the transmitting the status query signal to the second chip through the SPI;
transmitting a third signal to the second chip through the SPI, wherein the third signal is used for notifying the second chip that the first transmission data is about to be transmitted to the second chip, to cause the second chip to be ready to transmit the first preset status signal.

19. The computer-readable storage medium according to claim 18, wherein before transmitting the third signal to the second chip through the SPI, the method further comprises:
transmitting the status query signal to the second chip through the SPI, and receiving a third signal transmitted by the second chip through the SPI; and
in response to the third signal being the second preset status signal, transmitting the third signal to the second chip through the SPI.

20. The computer-readable storage medium according to claim 19, wherein
in response to the third signal not being the second preset status signal, retransmitting the status query signal to the second chip through the SPI, until the second preset status signal is received.
